(19) United States
(12) Patent Application Publication
(10) Pub. No.: US 2024/0322293 A1
(43) Pub. Date: Sep. 26, 2024

(54) BATTERY PACK

(71) Applicant: SAMSUNG SDI CO., LTD., Yongin-si (KR)

(72) Inventors: Kilseok LEE, Yongin-si (KR); Beomjoo Kim, Yongin-si (KR)

(21) Appl. No.: 18/599,650

(22) Filed: Mar. 8, 2024

(30) Foreign Application Priority Data
Mar. 26, 2023 (KR) 10-2023-0039393
Oct. 30, 2023 (KR) 10-2023-0146991

(51) Int. Cl. H01M 10/6555; H01M 10/613; H01M 50/213; H01M 50/289; H01M 50/507; H01M 50/509

(52) U.S. Cl. CPC H01M 10/6555; H01M 10/613; H01M 50/213; H01M 50/289; H01M 50/507; H01M 50/509

(57) ABSTRACT

A battery pack including at least one battery cell including an electrode at an end of the at least one battery cell and an outer circumferential surface extending between the end and an opposite end of the at least one battery cell; and a connection cooling member extending from the end of the at least one battery cell towards the opposite end of the at least one battery cell along the outer circumferential surface of the at least one battery cell the connection cooling member and the electrode including a same metal and being integral with each other.

### CROSS-REFERENCE TO RELATED APPLICATION

The present application claims priority and the benefit of Korean Patent Application No. 10-2023-0039393, filed on Mar. 26, 2023, and Korean Patent Application No. 10-2023-0146991, filed on Oct. 30, 2023, in the Korean Intellectual Property Office, the entire disclosures of which are incorporated herein by reference in their entireties.

### BACKGROUND

### 1. Field

One or more embodiments relate to a battery pack, and more particularly, to a battery pack including a connection cooling member extending integrally with an electrode at an end of a battery cell on an outer circumferential surface of the battery cell.

### 2. Description of the Related Art

Battery modules or battery packs used in electric vehicles include a group of a plurality of battery cells. In this regard, a function of effectively cooling battery cells due to heat generated therein may be significant. Traditional cooling methods may include a bottom cooling method for cooling a bottom of a battery cell and a side cooling method for cooling a side of the battery cell. Battery cells used in electric vehicles, etc., are getting larger. If circular battery cells are used, a size increase of the battery cells may mean that diameters and heights of the battery cells increase. With the enlargement of the battery cells, there may be a limitation in achieving a cooling target with the bottom cooling method.

### SUMMARY

Embodiments are directed to a battery pack including at least one battery cell including an electrode at an end of the at least one battery cell and an outer circumferential surface extending between the end and an opposite end of the at least one battery cell; and a connection cooling member extending from the end of the at least one battery cell towards the opposite end of the at least one battery cell along the outer circumferential surface of the at least one battery cell the connection cooling member and the electrode including a same metal and being integral with each other.

The connection cooling member may include a bus portion at the end of the at least one battery cell and a cooling portion on the outer circumferential surface of the at least one battery cell.

The at least one battery cell may include a plurality of battery cells arranged in a first column and a second column adjacent to the first column.

The bus portion may electrically connect the plurality of battery cells arranged in the first column and the second column.

The bus portion may electrically connect, from among the plurality of battery cells in the first column and the second column, battery cells belonging to a same column in parallel to each other and battery cells belonging to different columns in series.

Each battery cell in the plurality of battery cells may include the first electrode at a center of the end of the at least one battery cell and a second electrode at an edge of the end of the at least one battery cell, the bus portion may include a plurality of first branch portions each connected to a first electrode of a respective battery cell in the first column, a plurality of second branch portions each connected to a second electrode of a respective battery cell in the second column, and a body portion connected to the plurality of first branch portions and the plurality second branch portions, and each of the plurality of first branch portions and each of the plurality of second branch portions may protrude from the body portion in opposite directions toward their respective battery cells.

The connection cooling member may include a plurality of cooling portions each contacting an outer circumferential surface of a respective battery cell in the plurality of battery cells in one column among the plurality of battery cells in the first column and the second column.

The body of the bus portion may extend in a zigzag pattern between the plurality of battery cells in the first column and the second column.

The connection cooling member may be coupled to a holder accommodating the at least one battery cell via an insert-injection structure.

The connection cooling member may be coupled to a holder accommodating the at least one battery cell via adhesion.

The battery pack may further include a cooling tube on the bus portion.

### BRIEF DESCRIPTION OF THE DRAWINGS

Features will become apparent to those of skill in the art by describing in detail exemplary embodiments with reference to the attached drawings in which:

FIG. 1 shows a perspective view of a three-dimensional structure of a battery pack according to embodiments of the present disclosure;

FIG. 2 shows a perspective view of a structure of a battery cell shown in FIG. 1;

FIG. 3 shows a perspective view of a three-dimensional structure of a connection cooling member shown in FIG. 1;

FIG. 4 shows a perspective view of a three-dimensional structure of a holder shown in FIG. 1;

FIG. 5 is a cross-sectional view of the battery pack cut along a line V-V in FIG. 1;

FIG. 6 is a cross-sectional view of the battery pack cut along a line VI-VI in FIG. 1; and

FIG. 7 shows a perspective view of a structure of arranging a cooling tube according to the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In addition, in describing embodiments of the present disclosure in detail, when it is determined that a detailed description of a related known function or configuration may unnecessarily obscure the gist of the present disclosure, the detailed description will be omitted. Moreover, the same reference numerals are used for parts having similar functions and actions throughout the drawings.

When a portion is referred to as “includes” a component, the portion may not exclude another component but may further include another component unless stated otherwise. More specifically, it should be understood that the term “include”, “have”, or the like used herein is to indicate the presence of features, numbers, steps, operations, components, parts, or a combination thereof described in the specifications, and does not preclude the presence or addition of one or more other features, numbers, steps, operations, components, parts, or a combination thereof.

Singular forms may include plural forms unless apparently indicated otherwise contextually. In addition, the shapes and sizes of components in the drawings may be exaggerated for the clearer description.

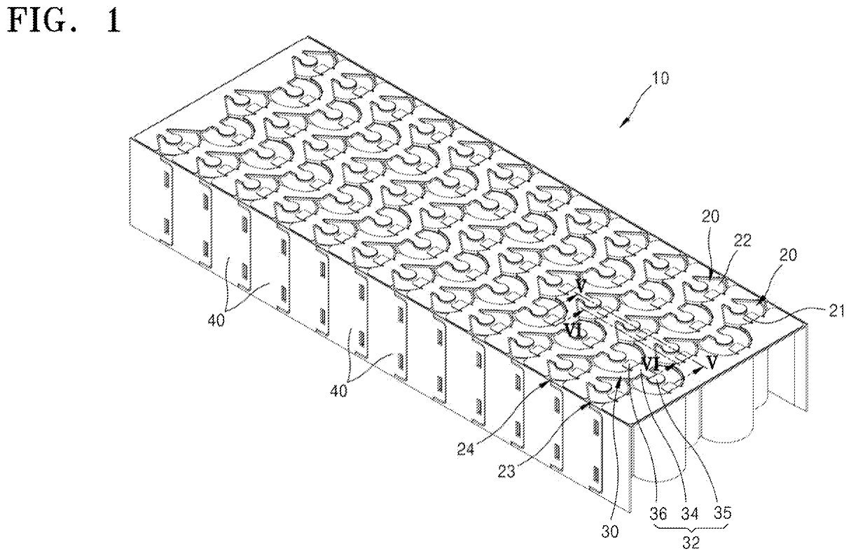

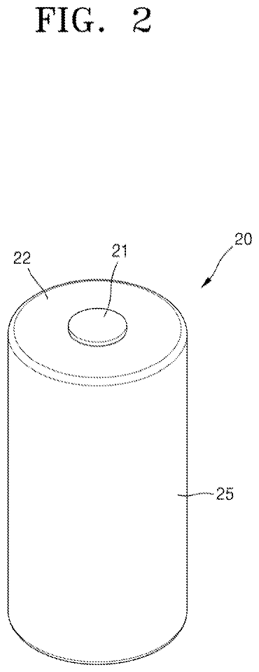

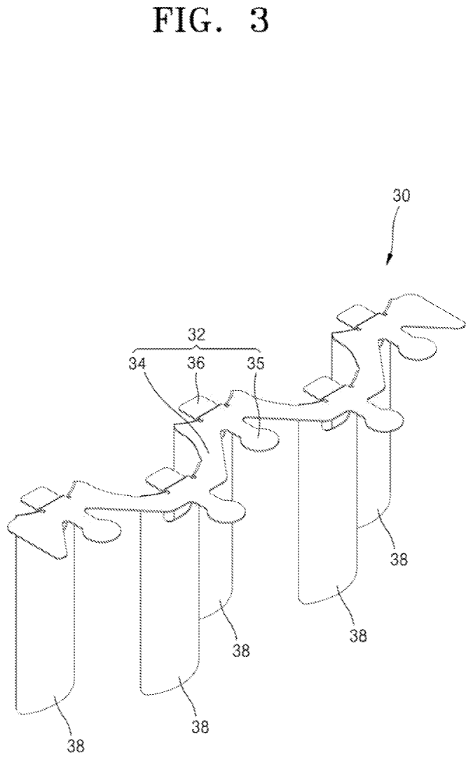

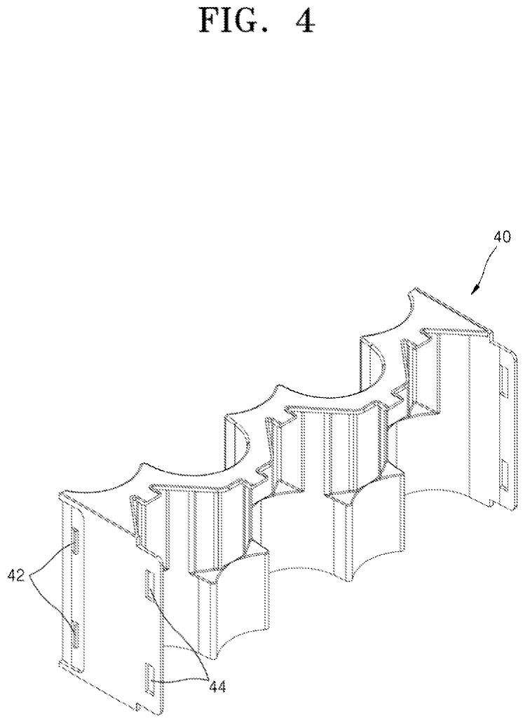

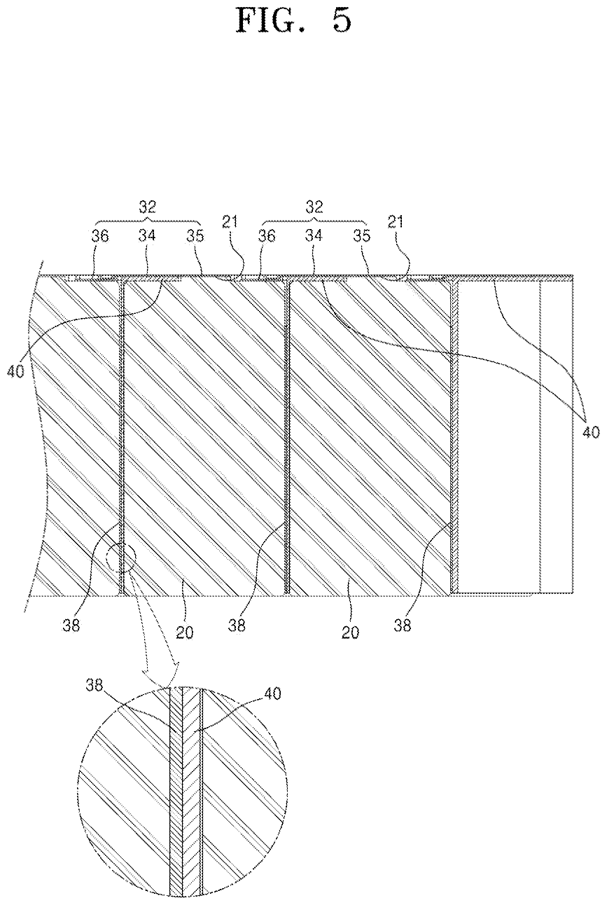

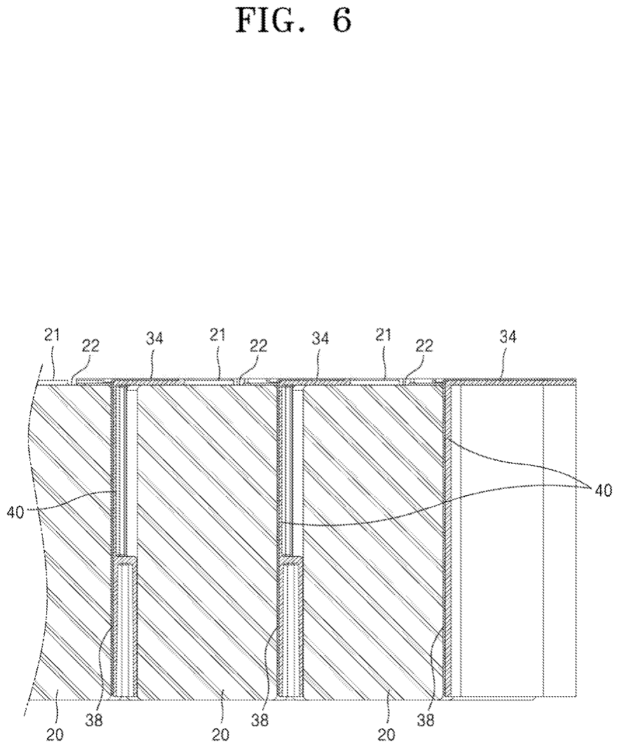

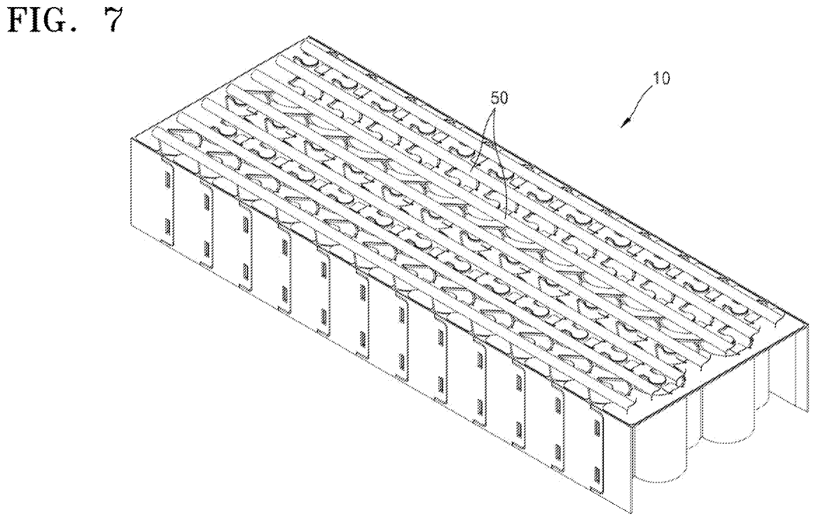

FIG. 1 shows a three-dimensional structure of a battery pack according to embodiments of the present disclosure. FIG. 2 shows a structure of a battery cell shown in FIG. 1. FIG. 3 shows a three-dimensional structure of a connection cooling member shown in FIG. 1. FIG. 4 shows a three-dimensional structure of a holder shown in FIG. 1. FIG. 5 is a cross-sectional view of the battery pack cut along a line V-V in FIG. 1. FIG. 6 is a cross-sectional view of the battery pack cut along a line VI-VI in FIG. 1. FIG. 7 shows a structure of arranging a cooling tube according to the present disclosure.

Referring to FIGS. 1 to 7, a battery pack 10 according to the present disclosure may include a battery cell 20, a connection cooling member 30, and a holder 40.

A plurality of battery cells 20 may be provided. In an implementation, the battery cell 20 may be a circular battery cell. An electrode may be formed at an end of the battery cell 20. The battery cells 20 may include an external outer surface 25 extending between an end and the opposite end of the battery cell 20. Generally, the electrode formed at the end of the battery cell 20 may be a positive (+) electrode. The outer circumferential surface 25 may be a negative (−) electrode. The plurality of battery cell 20 may include battery cells 20 in a first column 23 and a second column 24 that are arranged adjacent to each other. The battery cells 20 constituting the first column 23 may be arranged in a zigzag pattern. The battery cells 20 constituting the second column 24 may be arranged in a zigzag pattern. A first electrode 21 formed at the center of the battery cell 20 and a second electrode 22 formed at the edge of the battery cell 20 may be formed at an end of the battery cell 20. If the first electrode 21 is a positive electrode, the second electrode 22 may be a negative electrode.

The battery cell 20 may be accommodated in the holder 40. The holder 40 may include an electrically insulating material. The holder 40 may be formed by coupling a plurality of structures. Adjacent holders 40 may be assembled together by coupling between a catching protrusion 42 and a coupling hole 44.

The battery cell 20 may be accommodated in the connection cooling member 30. The connection cooling member 30 may include a metal. The connection cooling member 30 may be a structure extending from the same first metal, integrally with the electrode at the end of the battery cell 20 on the outer circumferential surface 25. The first metal may be, e.g., aluminum (Al). For example, as illustrated in FIG. 3, the connection cooling member 30 may be a single structure that extends from the end of the battery cell 20 towards the opposite end of the battery cell 20 along the outer circumferential surface 25 of the battery cell 20.

The connection cooling member 30 may include a bus portion 32 and a cooling portion 38. The bus portion 32 may be formed at the end of the battery cell 20. The bus portion 32 may electrically connect adjacent battery cells 20. The cooling portion 38 may be formed on the outer circumferential surface 25 of the battery cell 20. The cooling portion 38 may be a structure extending from the bus portion 32 along the outer circumferential surface 25 of the battery cell 20. The surface of the cooling portion 38 may be insulated. The cooling portion 38 may be adhered to the outer circumferential surface 25 of the battery cell 20 via an adhesive, while maintaining insulation. The cooling portion 38 may be adhered to the outer circumferential surface 25 of the battery cell 20 of any one column among the battery cells 20 in the first column 23 and the second column 24. If the cooling portion 38 contacts the outer circumferential surface 25 of the battery cell 20, heat transfer efficiency from the battery cell 20 to the cooling portion 38 may be improved. In an implementation, as illustrated in FIGS. 1 and 3, the connection cooling member 30 may include a plurality of cooling portions 38 that may each contact a respective battery cell 20 of the plurality of battery cells in one column among the plurality of battery cells in the first column 23 and the second column 24.

The bus portion 32 may electrically connect the battery cells 20 in the first column 23 and the second column 24 that are arranged adjacent to each other. In an implementation, the bus portion 32 may be configured to connect in parallel, the battery cells 20 belonging to the same column among the battery cells 20 constituting the first column 23 and the second column 24 and to connect in series, the battery cells 20 belonging to different columns among the battery cells 20 constituting the first column 23 and the second column 24.

The bus portion 32 may include a main body 34, a first branch portion 35, and a second branch portion 36.

The main body 34 may be a frame constituting the bus portion 32. The main body 34 may extend in the zigzag pattern between the battery cells 20 in the first column 23 and the second column 24 extending in the zigzag pattern.

The first branch portion 35 may be a structure having a cantilever shape extending from the main body 34. The first branch portion 35 may be connected to a first electrode 21 of the battery cell 20 in the first column 23.

The second branch portion 36 may be a structure having a cantilever shape extending from the main body 34. The second branch portion 36 may be connected to a second electrode 22 of the battery cell 20 in the second column 24.

The first branch portion 35 and the second branch portion 36 may protrude in opposite directions toward the battery cells 20 in the first column 23 and the second column 24 facing each other from the main body 34 of the bus portion 32. For example, as illustrated in FIG. 3, the first branch portion 35 and the second branch portion 36 may protrude in opposite directions from one another and be across from one another on opposite sides of the main body 34. In an implementation, as illustrated in FIGS. 1 and 3, the bus portion may include a plurality of first branch portions 35 and second branch portions 36.

In an implementation, the connection cooling member 30 may be coupled to the holder 40 accommodating the battery cell 20 via an insert-injection structure. In another implementation, the connection cooling member 30 may be coupled to the holder 40 accommodating the battery cell 20 via adhesion.

A cooling tube 50 through which a coolant flows may be arranged on the bus portion 32. The cooling tube 50 may be adhered to the bus portion 32. The cooling tube 50 and the bus portion 32 may be adhered to each other to maintain electric insulation from each other. A plurality of cooling tubes 50 may be provided. The cooling tube 50 may be adhered to the bus portion 32, by using, e.g., a glue. If the cooling tube 50 and the bus portion 32 are adhered by the bond, the strength of a laser weldment of the bus portion 32 may be reinforced, thereby improving durability.

Hereinbelow, the working effect of the connection cooling member 30 in the battery pack 10 including the above-described components will be described in detail.

Referring to FIGS. 5 and 6, if heat is generated in the battery cells 20 constituting the battery pack 10, the cooling portion 38 of the connection cooling member 30 may quickly transfer heat upwardly or downwardly from the side of the battery cell 20. If the heat is transferred from the cooling portion 38 to the bus portion 32, heat exchange may be made through the cooling tube 40 arranged on the bus portion 32, thereby effectively cooling the heat generated in the battery cell 20. In the present disclosure, the cooling portion 38 constituting the connection cooling member 30 may be a structure in the shape of a plate, rather than a tube structure through which the coolant flows. Thus, the cooling portion 38 may have a thin thickness, e.g., about 0.5 mm. As a result, a space occupied by the cooling portion 38 may be small. In a conventional side cooling structure, a cooling tube through which the coolant flows may be provided, and the thickness of the cooling tube may be at least 3 mm or greater. Thus, the space efficiency of the cooling portion 38 of the connection cooling member 30 according to the present disclosure may be significantly improved when compared to the conventional side cooling tube structure.

Moreover, as the cooling portion 38 and the bus portion 32 of the connection cooling member 30 may be formed integrally with each other, e.g., as a single piece, a material cost and a process cost may be reduced in comparison to a conventional structure.

As described above, the battery pack according to the present disclosure may include the connection cooling member extending from the same first metal, integrally with the electrode at the end of the battery cell on the outer circumferential surface, thereby allowing heat generated in the side of the battery cell to quickly moving upwardly or downwardly in the battery cell through the connection cooling member, and as the connection cooling member also serves as a bus bar, space efficiency may be improved and a material cost and a process cost may be reduced.

By way of summation and review, as a result of larger battery cells, side cooling methods for cooling the sides of the battery cells have attracted attention. For example, TESLA vehicles employ a side cooling method to cool battery cells. According to a conventional side cooling method, a cooling tube may be arranged on a side of a battery cell. As a result, the cost of a material of a component and the cost of process configuration for forming a cooling structure may increase. Moreover, a thickness of the cooling tube may need to be secured, which may degrade the efficiency of space utilization.

One or more embodiments include a battery pack with an improved side cooling structure of a battery cell, thereby improving cooling performance, optimizing space utilization, and reducing a material cost.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack comprising:
at least one battery cell including an electrode at an end of the at least one battery cell and an outer circumferential surface extending between the end and an opposite end of the at least one battery cell; and
a connection cooling member extending from the end of the at least one battery cell towards the opposite end of the at least one battery cell along the outer circumferential surface of the at least one battery cell the connection cooling member and the electrode including a same metal and being integral with each other.

2. The battery pack as claimed in claim 1, wherein the connection cooling member includes a bus portion at the end of the at least one battery cell and a cooling portion on the outer circumferential surface of the at least one battery cell.

3. The battery pack as claimed in claim 2, wherein the at least one battery cell includes a plurality of battery cells arranged in a first column and a second column adjacent to the first column.

4. The battery pack as claimed in claim 3, wherein the bus portion electrically connects the plurality of battery cells arranged in the first column and the second column.

5. The battery pack as claimed in claim 3, wherein the bus portion electrically connects, from among the plurality of battery cells in the first column and the second column, battery cells belonging to a same column in parallel to each other and battery cells belonging to different columns in series.

6. The battery pack as claimed in claim 4, wherein:
each battery cell in the plurality of battery cells includes the first electrode at a center of the end of the at least one battery cell and a second electrode at an edge of the end of the at least one battery cell,
the bus portion includes a plurality of first branch portions each connected to a first electrode of a respective battery cell in the first column, a plurality of second branch portions each connected to a second electrode of a respective battery cell in the second column, and a body portion connected to the plurality of first branch portions and the plurality second branch portions, and
each of the plurality of first branch portions and each of the plurality of second branch portions protrudes from the body portion in opposite directions toward their respective battery cells.

7. The battery pack as claimed in claim 4, wherein the connection cooling member includes a plurality of cooling portions each contacting an outer circumferential surface of a respective battery cell in the plurality of battery cells in one column among the plurality of battery cells in the first column and the second column.

8. The battery pack as claimed in claim 6, wherein the body of the bus portion extends in a zigzag pattern between the plurality of battery cells in the first column and the second column.

9. The battery pack as claimed in claim 1, wherein the connection cooling member is coupled to a holder accommodating the at least one battery cell via an insert-injection structure.

10. The battery pack as claimed in claim 1, wherein the connection cooling member is coupled to a holder accommodating the at least one battery cell via adhesion.

11. The battery pack as claimed in claim 1, further comprising a cooling tube on the bus portion.
